(19) United States
(12) Patent Application Publication
(10) Pub. No.: US 2012/0132451 A1
(43) Pub. Date: May 31, 2012

(54) Hammer mechanism

(76) Inventors: Joachim HECHT, Magstadt (DE); Martin Kraus, Filderstadt (DE)

(21) Appl. No.: 13/305,485

(22) Filed: Nov. 28, 2011

(30) Foreign Application Priority Data
Nov. 29, 2010 (DE) 10 2010 062 099.8

(51) Int. Cl. B23B 45/16; B25D 17/00; B25D 16/00

(52) U.S. Cl. 173/48; 173/112

(57) ABSTRACT

A hammer mechanism is described as having a snap die, a tool chuck drive shaft, and an impact generating shutoff unit, which has a blocking element, which is provided for the purpose of preventing an axial displacement of the snap die. The blocking element acts on the snap die in parallel to at least one force of the tool chuck drive shaft, at least during a drilling operation.

### RELATED APPLICATION INFORMATION

The present application claims priority to and the benefit of German patent application no. 10 2010 062 099.8, which was filed in Germany on Nov. 29, 2010, the disclosure of which is incorporated herein by reference.

### FIELD OF THE INVENTION

The present invention is directed to a hammer mechanism.

### BACKGROUND INFORMATION

A hammer mechanism having a snap die, a tool chuck drive shaft, and an impact generating shutoff unit, which has a blocking element, which is provided for the purpose of preventing an axial displacement of the snap die, has already been proposed.

### SUMMARY OF THE INVENTION

The exemplary embodiments and/or exemplary methods of the present invention is directed to a hammer mechanism having a snap die, a tool chuck drive shaft, and an impact generating shutoff unit, which has a blocking element, which is provided for the purpose of preventing an axial displacement of the snap die.

The blocking element acts parallel to at least one force of the tool chuck drive shaft on the snap die, at least during a drilling operation. A “snap die” is to be understood in particular as an element of the hammer mechanism which transmits an impact momentum from a striker in the direction of an insertion tool during impact operation. The snap die may strike directly on the insertion tool in at least one operating state. The snap die may prevent penetration of dust through a tool chuck into the hammer mechanism. A “tool chuck drive shaft” is to be understood in particular as a shaft which transmits a rotational movement from a gear, in particular a planetary gear, in the direction of the tool chuck during rotary and/or percussion drilling operation. The tool chuck drive shaft is advantageously at least partially configured as a solid shaft. The tool chuck drive shaft may extend over at least 40 mm in the striking direction. The tool chuck drive shaft and the tool chuck may have an equal rotational speed during rotary and/or percussion drilling operation, in particular always, i.e., in particular a drivetrain between the tool chuck drive shaft and the tool chuck is free of a gear.

An “impact generating shutoff unit” is to be understood in particular as a unit which is provided for the purpose of allowing an operator to shut off the impact generating unit for a drilling and/or screwing operation. The impact generating shutoff unit may prevent automatic activation in particular of the impact generating unit when the insertion tool is pressed against a workpiece in a drilling and/or screwing mode. Contact pressure in a chisel and/or percussion drilling mode may cause an axial displacement of the tool chuck drive shaft.

The blocking element is advantageously provided for the purpose of preventing an axial displacement of the tool chuck drive shaft, the tool chuck, and/or advantageously the snap die in the drilling and/or screwing mode. “Provided” is to be understood in particular as specially configured and/or equipped. The term “parallel to a force” is to be understood in particular to mean that the tool chuck drive shaft and the blocking element cause a force on the snap die at two different positions in at least one operating state. Alternatively or additionally, the tool chuck drive shaft and the blocking element may exert a force on the tool chuck at two different positions in at least one operating state. The forces may have a component oriented in the same direction, which may be parallel to the rotational axis of the tool chuck drive shaft, from the tool chuck drive shaft in the direction toward the tool chuck. The blocking element may act directly on the snap die, however, which may particularly be at least via one tool chuck bearing. The tool chuck drive shaft may act directly on the snap die. The snap die may transmit a rotational movement from the tool chuck drive shaft to the tool chuck. Through the embodiment according to the present invention, an advantageous arrangement of an operating element of the impact generating shutoff unit may be achieved with a simple configuration. In particular, a ring-shaped operating element, which encloses the snap die or the tool chuck drive shaft, is easily implementable. In addition, little installation space is required with this configuration.

In another embodiment, it is proposed that the impact generating shutoff unit have a sliding guide, which is provided for the purpose of moving the blocking element, whereby low production costs and a high level of robustness may be achieved. A “sliding guide” is to be understood in particular as a device in which a bevel of an element presses the blocking element from one position into another position in the event of a movement of the element. A “bevel” is to be understood in particular as an inclined face of the element in relation to a direction of the movement. The sliding guide may have a face which axially fixes the tool chuck via the blocking element in at least one operating state.

Furthermore, it is proposed that the impact generating shutoff unit have a rotatably mounted operating element, whereby a particularly ergonomic operation is possible. A “rotatably mounted operating element” is to be understood in particular as an element, using which the hammer mechanism may be switched from one operating mode into another operating mode by a rotational movement of the operating element. The operating element may enclose a rotational axis of the tool chuck drive shaft. The operating element may be rotatable around an axis which is oriented parallel to the tool chuck drive shaft.

Furthermore, it is proposed that the hammer mechanism have a housing element, which is provided for the purpose of mounting the blocking element in a rotationally fixed manner, whereby a configuration having a particularly simple configuration is possible. The term “mount in a rotationally fixed manner” is to be understood in particular to mean that the blocking element is mounted so it is translationally movable.

In an advantageous embodiment of the present invention, it is proposed that the hammer mechanism have a striker, which mounts the tool chuck drive shaft so it is movable in the striking direction in at least one operating state, whereby a low weight and a small overall size are possible. In particular, the term “striker” is to be understood as an arrangement of the hammer mechanism, which is provided for the purpose of being translationally accelerated in particular during operation by the impact generating unit and delivering a momentum absorbed during the acceleration as an impact momentum in the direction of the insertion tool. The striker may be mounted so it may be accelerated in the striking direction by an air pressure or advantageously by a rocker. The striker may be unaccelerated immediately before an impact. The striker may deliver an impact momentum in the direction of the insertion tool, in particular via a snap die, to the insertion tool in the case of an impact. A “rocker” is to be understood in particular as an arrangement which is mounted movably around a pivot axis and which is provided for the purpose of delivering power absorbed on a first coupling area to a second coupling area. A “striking direction” is to be understood in particular as a direction which runs parallel to a rotational axis of the tool chuck and is oriented from the striker in the direction toward the tool chuck. The striking direction may be oriented parallel to a rotational axis of the tool chuck drive shaft. The term “mounted so it is movable” is to be understood in particular to mean that the tool chuck drive shaft has a bearing surface, which transmits bearing forces perpendicularly to the striking direction onto the striker in at least one operating state.

Furthermore, it is proposed that the tool chuck drive shaft at least partially penetrate the striker, whereby a tool chuck drive shaft may be provided having a particularly small mass and a small installation space requirement. In particular, the term “at least partially penetrate” is to be understood to mean that the striker encloses the tool chuck drive shaft by more than 270°, advantageously by 360°, on at least one plane, which is advantageously oriented perpendicularly to the striking direction. The striker may be fastened in a form-locked manner on the tool chuck drive shaft in a direction perpendicular to the rotational axis of the tool chuck drive shaft, i.e., mounted so it is movable in the direction of the rotational axis.

In addition, it is proposed that the hammer mechanism include at least one bearing, which is provided for the purpose of mounting the tool chuck drive shaft so it is axially displaceable, whereby an impact mechanism shutoff having a simple configuration is possible. A “bearing” is to be understood in particular as a device which fastens the tool chuck drive shaft in particular so it is movable at least around the rotational axis and axially displaceable in relation to a housing. “Axially displaceable” is to be understood in particular to mean that the bearing fastens the tool chuck drive shaft so it is movable parallel to the striking direction, in particular in relation to a housing. A connection of the coupling arrangement of the tool chuck drive shaft, which drives the impact generating unit, may be disengaged by an axial displacement of the tool chuck drive shaft.

Furthermore, it is proposed that the hammer mechanism have a planetary gear, which drives the tool chuck drive shaft in at least one operating state, whereby an advantageous transmission ratio may be achieved in a small space. Furthermore, torque limiting and multiple gear stages may be implemented with a simple configuration. A “planetary gear” is to be understood in particular as a unit having at least one planet wheel set. A planet wheel set may have a sun wheel, an annulus gear, a planet wheel carrier, and at least one planet wheel guided by the planet wheel carrier on an orbit around the sun wheel. The planetary gear may have at least two transmission ratios, which are selectable by an operator, between an input and an output of the planetary gear.

Furthermore, it is proposed that the snap die have a coupling arrangement, which is provided for transmitting a rotational movement to a tool chuck, whereby a particularly compact hammer mechanism may be provided. The snap die advantageously transmits a rotational movement of the tool chuck drive shaft to the tool chuck. The term “tool chuck” is to be understood in particular as a device which is provided for the purpose of directly fastening an insertion tool so it may be disengaged by an operator in particular without tools, and at least in a rotationally fixed manner.

Furthermore, it is proposed that the hammer mechanism include an impact generating unit and a coupling arrangement, which is connected in a rotationally fixed manner to the tool chuck drive shaft and which is provided for the purpose of driving the impact generating unit, whereby a particularly compact and high-performance hammer mechanism may be provided with a simple configuration. An “impact generating unit” is to be understood in particular as a unit which is provided for the purpose of converting a rotational movement into an impact movement of the striker, in particular a translational movement, which is suitable for rotary and percussion drilling operation. In particular, the impact generating unit is configured as an impact generating unit which appears meaningful to a person skilled in the art, but which may be configured as a pneumatic impact generating unit and/or which may particularly be configured as an impact generating unit having the rocker.

A “coupling arrangement” is to be understood in particular as a arrangement which is provided for the purpose of transmitting a movement from one component to another component at least by a form lock. The form lock may be configured in such a way that it may be disengaged by the operator in at least one operating state. The form lock may particularly be disengaged to switch over an operating mode, advantageously between screwing operation, drilling operation, chisel operation, and/or percussion drilling operation. In particular, the coupling arrangement is configured as a coupling which appears meaningful to a person skilled in the art, but advantageously as a claw coupling and/or a gearing. The coupling arrangement advantageously has multiple form-locked elements and an area which connects the form-locked elements. In particular, the term “rotationally fixed” is to be understood to mean that the coupling arrangement and the tool chuck drive shaft are fixedly connected to one another at least in the peripheral direction, which may be in every direction, and in particular in every operating state. In particular, “driving” is to be understood in this context to mean that the coupling arrangement transmits a kinetic energy, in particular a rotational energy, to at least one area of the impact generating unit. The impact generating unit may drive the striker using this energy. Through the embodiment according to the present invention, a particularly compact and high-performance hammer mechanism may be provided, having a simple configuration.

In addition, the hammer mechanism has a spur gear stage, which converts a rotational speed of the tool chuck drive shaft into a higher rotational speed for impact generation, whereby a particularly advantageous ratio between rotational speed and impact count of an insertion tool may be achieved with a simple configuration and in a space-saving way. A “spur gear stage” is to be understood in particular as an arrangement of two meshing gearwheels in particular, which are mounted rotatably around parallel axes. The gearwheels may have a gearing on a surface facing away from their axis. In particular, a “rotational speed for impact generation” is to be understood as a rotational speed of a drive arrangement, which appears meaningful to a person skilled in the art, of the impact generating unit, which converts a rotational movement into a linear movement. The drive arrangement of the impact generating unit may be configured as a wobble bearing or particularly may be configured as an eccentric element. “Converting” is to be understood here to mean that the rotational speed of the tool chuck drive shaft and the rotational speed for impact generation differ. The rotational speed for impact generation may be greater, advantageously at least twice as great as the rotational speed of the tool chuck drive shaft. A transmission ratio of the rotational speed for impact generation to the rotational speed of the tool chuck drive shaft particularly may be a non-integer number.

Furthermore, the hammer mechanism includes a torque limiting device, which is provided for the purpose of limiting a maximum torque which may be transmitted via the tool chuck drive shaft, whereby the operator is advantageously protected and the handheld tool may be used comfortably and efficiently for screwing. “Limiting” is to be understood in particular in this context to mean that the torque limiting device prevents the maximum torque, which is settable in particular by an operator, from being exceeded. The torque limiting device may open a connection between a drive motor and the tool chuck, which is rotationally fixed during operation. Alternatively or additionally, the torque limiting device may act on a power supply of the drive motor.

Furthermore, a handheld tool having a hammer mechanism according to the present invention is described. A “handheld tool” is to be understood in this context in particular as a handheld tool which appears meaningful to a person skilled in the art, but which may be a drill, a rotary hammer drill, an electric screwdriver, a drill chisel, and/or a percussion hammer. The handheld tool may be configured as a battery-powered handheld tool, i.e., in particular the handheld tool has a coupling arrangement, which is provided for the purpose of supplying a drive motor of the handheld tool with electrical power from a handheld tool battery connected to the coupling arrangement.

Further advantages result from the following description of the drawings. Five exemplary embodiments of the present invention are shown in the drawings. The drawings, the description, and the claims contain numerous features in combination. A person skilled in the art will advantageously also consider the features individually and combine them into meaningful further combinations.

### BRIEF DESCRIPTION OF THE DRAWINGS

FIG. 1 shows a handheld tool having a hammer mechanism according to the present invention in a perspective view.

FIG. 2 shows a section of the hammer mechanism from FIG. 1.

FIG. 3 shows a coupling arrangement, a tool chuck drive shaft, a snap die, and a part of a tool chuck of the hammer mechanism from FIG. 1, each shown individually in a perspective view.

FIG. 4 shows another partial section of the hammer mechanism from FIG. 1, which shows an impact generating shutoff unit of the hammer mechanism.

FIG. 5 shows a first alternative exemplary embodiment of a snap die of the hammer mechanism from FIG. 1 in a schematic view.

FIG. 6 shows a second alternative exemplary embodiment of a snap die of the hammer mechanism from FIG. 1 in a schematic view.

FIG. 7 shows a third alternative exemplary embodiment of a snap die of the hammer mechanism from FIG. 1 in a sectional view.

FIG. 8 shows the snap die from FIG. 7 in a first perspective view.

FIG. 9 shows the snap die from FIG. 7 in a second perspective view.

FIG. 10 shows a part of a tool chuck of the hammer mechanism from FIG. 7 in a perspective view.

FIG. 11 shows a fourth alternative exemplary embodiment of a snap die of the hammer mechanism from FIG. 1 in a schematic view.

### DETAILED DESCRIPTION

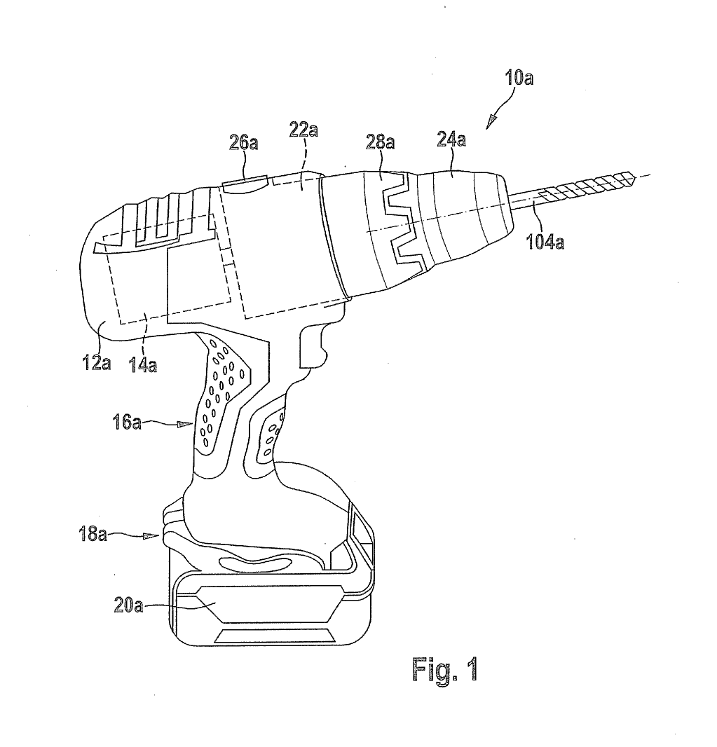

FIG. 1 shows a handheld tool 10a, which is configured as a rotary hammer drill. Handheld tool 10a has a pistol-shaped housing 12a. A drive motor 14a of handheld tool 10a is situated in housing 12a. Housing 12a has a handle area 16a and a battery coupling arrangement 18a, which is situated on an end of handle area 16a facing away from drive motor 14a. Battery coupling arrangement 18a couples a handheld tool battery 20a in a way which may be electrically and mechanically disconnected by an operator. Handheld tool battery 20a has an operating voltage of 10.8 V, but may also have a different, in particular a higher, operating voltage. Furthermore, handheld tool 10a has a hammer mechanism 22a according to the present invention, having an externally situated tool chuck 24a and operating elements 26a, 28a.

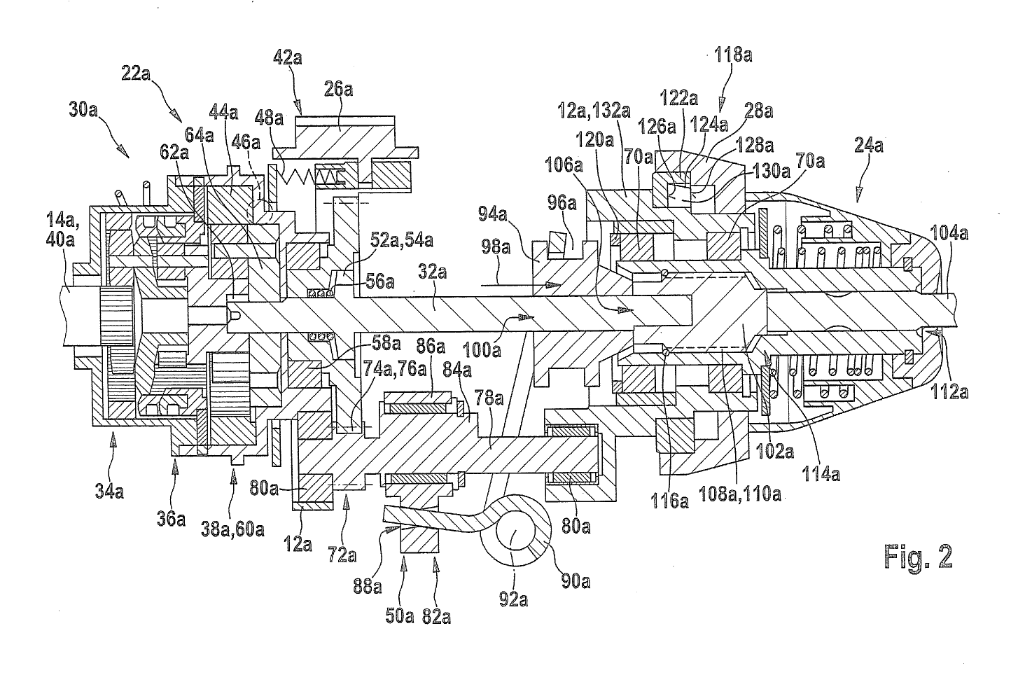

FIG. 2 shows hammer mechanism 22a in a sectional view. Furthermore, hammer mechanism 22a includes a planetary gear 30a and a tool chuck drive shaft 32a. Planetary gear 30a drives tool chuck drive shaft 32a to rotate around an rotational axis during operation. For this purpose, planetary gear 30a has three planetary gear stages 34a, 36a, 38a. A transmission ratio of planetary gear 30a between a rotor 40a of drive motor 14a and tool chuck drive shaft 32a is settable by an operator in at least two stages. Alternatively, a transmission ratio between drive motor 14a and tool chuck drive shaft 32a may be nonadjustable.

Hammer mechanism 22a has a torque limiting device 42a. Torque limiting device 42a holds an annulus gear 44a of planetary gear 30a fixed during operation. For this purpose, torque limiting device 42a has fixation balls 46a, which engage in recesses of annulus gear 44a. A spring 48a of torque limiting device 42a exerts a force on fixation balls 46a in the direction of annulus gear 44a for this purpose. An end of spring 48a facing toward fixation balls 46a is movable in the direction of fixation balls 46a by an operator with the aid of one of operating elements 26a. For this purpose, operating element 26a has an eccentric element. The force acting on fixation balls 46a is therefore settable. When a certain maximum torque is reached, fixation balls 46a are pressed out of the recesses and annulus gear 44a runs free, whereby a force transmission between rotor 40a and tool chuck drive shaft 32a is interrupted. Torque limiting device 42a is therefore provided for the purpose of limiting a maximum torque transmittable via tool chuck drive shaft 32a.

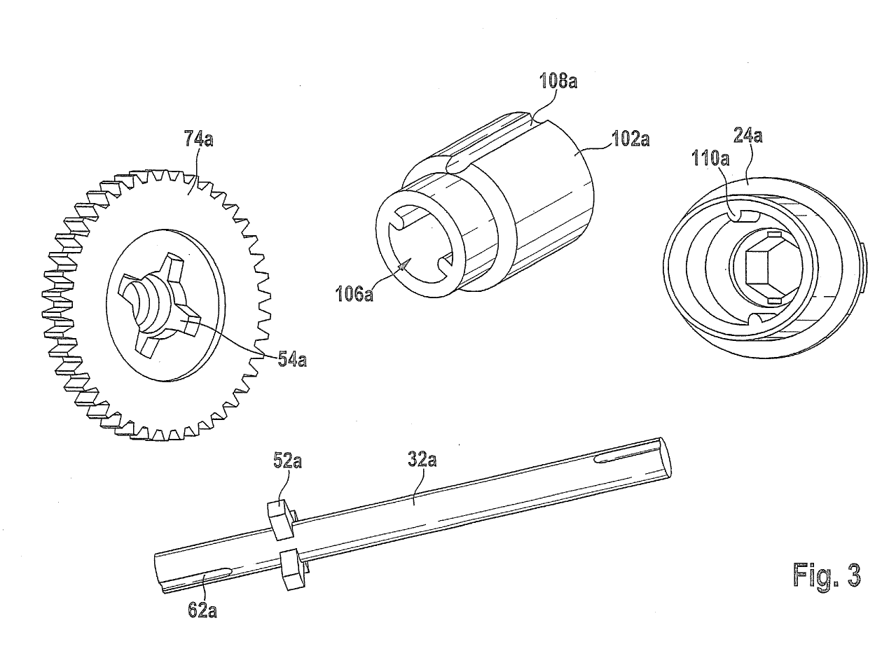

Hammer mechanism 22a has an impact generating unit 50a and a first coupling arrangement 52a. First coupling arrangement 52a is connected in a rotationally fixed manner to tool chuck drive shaft 32a; in fact, first coupling arrangement 52a and tool chuck drive shaft 32a are formed in one piece. Impact generating unit 50a has a second coupling arrangement 54a, which is connected in a rotationally fixed manner to first coupling arrangement 52a in a rotary and/or percussion drilling mode. As also shown in FIG. 3, first coupling arrangement 52a is configured as molds and second coupling arrangement 54a is configured as recesses. In the event of an activation of the drilling mode, first coupling arrangement 52a plunges completely into second coupling arrangement 54a. The coupling between first coupling arrangement 52a and second coupling arrangement 54a may therefore be disengaged by an axial displacement of tool chuck drive shaft 32a in the direction of tool chuck 24a. A spring 56a of hammer mechanism 22a is situated between first coupling arrangement 52a and second coupling arrangement 54a. Spring 56a presses tool chuck drive shaft 32a in the direction of tool chuck 24a. The spring opens the coupling between first coupling arrangement 52a and second coupling arrangement 54a when impact generating unit 50a is shut off.

Hammer mechanism 22a has a first bearing 58a, which fixes second coupling arrangement 54a in relation to housing 12a in the axial direction and mounts it so it is rotatable coaxially to tool chuck drive shaft 32a. Furthermore, hammer mechanism 22a has a second bearing 60a, which mounts tool chuck drive shaft 32a so it is rotatable around the rotational axis on a side facing toward drive motor 14a. Second bearing 60a is formed in one piece with one of three planetary gear stages 38a. Tool chuck drive shaft 32a has a coupling arrangement 62a, which connects it in an axially displaceable and rotationally fixed manner to a planet wheel carrier 64a of this planetary gear stage 38a. This planetary gear stage 38a is therefore provided for the purpose of mounting tool chuck drive shaft 32a so it is axially displaceable. On a side facing toward tool chuck 24a, tool chuck drive shaft 32a is mounted by a tool chuck bearing 70a so it is rotatable together with tool chuck 24a. Tool chuck bearing 70a has a rear bearing element, which is pressed in an axially fixed manner on tool chuck 24a. Furthermore, tool chuck bearing 70a has a front bearing element, which mounts tool chuck 24a so it is axially displaceable in housing 12a.

Impact generating unit 50a includes a spur gear stage 72a, which converts a rotational speed of tool chuck drive shaft 32a into a higher rotational speed for impact generation. A first gearwheel 74a of spur gear stage 72a is formed in one piece with second coupling arrangement 54a. During a percussion drilling operation, it is driven by tool chuck drive shaft 32a. A second gearwheel 76a of spur gear stage 72a is formed in one piece with an impact mechanism shaft 78a. A rotational axis of impact mechanism shaft 78a is situated adjacent in the radial direction to the rotational axis of tool chuck drive shaft 32a. Impact generating unit 50a has two bearings 80a, which mount the impact mechanism shaft 78a so it is rotatable and axially fixed. Impact generating unit 50a has a drive arrangement 82a, which converts a rotational movement of impact mechanism shaft 78a into a linear movement. An eccentric element 84a of drive arrangement 82a is formed in one piece with impact mechanism shaft 78a. An eccentric sleeve 86a of drive arrangement 82a is rotatably mounted on eccentric element 84a in relation to eccentric element 84a, with the aid of a needle bearing. Eccentric sleeve 86a has a recess 88a, which encloses a rocker 90a of impact generating unit 50a.

Rocker 90a is mounted so it is pivotable on a tilt axis 92a of impact generating unit 50a, specifically pivotable around an axis which is oriented perpendicularly to the rotational axis of tool chuck drive shaft 32a. An end of rocker 90a facing away from drive arrangement 82a partially encloses a striker 94a of hammer mechanism 22a. The rocker engages in a recess 96a of striker 94a. Recess 96a is configured in a ring shape. During a percussion drilling operation, rocker 90a causes a force on striker 94a which accelerates it. Rocker 90a is moved sinusoidally during operation. Rocker 90a has a resilient configuration. It has a spring constant between eccentric sleeve 86a and striker 94a of less than 100 N/mm and greater than 10 N/mm. In this exemplary embodiment, rocker 90a has a spring constant of approximately 30 N/mm.

Tool chuck drive shaft 32a mounts striker 94a movably in striking direction 98a. For this purpose, striker 94a delimits a recess 100a. Tool chuck drive shaft 32a penetrates striker 94a through recess 100a. Striker 94a encloses recess 100a over 360° in a plane perpendicular to recess 100a. During operation, striker 94a strikes a snap die 102a of hammer mechanism 22a. Snap die 102a is situated between an insertion tool 104a and striker 94a. In an operationally ready state, insertion tool 104a is fastened in tool chuck 24a. Tool chuck 24a mounts snap die 102a so it is movable parallel to striking direction 98a. Snap die 102a relays impact momentum, which comes from striker 94a during a percussion drilling operation, to insertion tool 104a.

Tool chuck drive shaft 32a is connected to snap die 102a so it is axially movable and rotationally fixed. For this purpose, snap die 102a delimits a recess 106a. In an operationally ready state, tool chuck drive shaft 32a is partially situated in recess 106a of snap die 102a. Tool chuck drive shaft 32a is mounted rotatably via snap die 102a, tool chuck 24a, and tool chuck bearing 70a. Tool chuck 24a is driven to rotate via snap die 102a. For this purpose, tool chuck 24a and snap die 102a each have a coupling arrangement 108a, 110a, the coupling arrangement being provided for transmitting the rotational movement to tool chuck 24a. Coupling arrangement 108a of snap die 102a is configured as a groove, whose main extension is situated parallel to striking direction 98a. Coupling arrangement 108a extends along a radial external lateral surface of snap die 102a. Coupling arrangement 110a of tool chuck 24a is configured as a protrusion which matches the groove.

Tool chuck 24a has an insertion tool coupling area 112a, in which insertion tool 104a is fastened so it is fixed in striking direction 98a during a drilling or screwing operation, or in which it is fastened so it is movable in striking direction 98a during a percussion drilling operation. In addition, the tool chuck has a taper 114a, which delimits a movement range of snap die 102a in striking direction 98a. Furthermore, tool chuck 24a has a fastening ring 116a, which delimits a movement range of snap die 102a against striking direction 98a.

During a percussion drilling procedure, an operator presses insertion tool 104a against a workpiece (not shown). The operator thus displaces insertion tool 104a, snap die 102a, and tool chuck drive shaft 32a in relation to housing 12a in a direction against striking direction 98a, i.e., in the direction of drive motor 14a. The operator compresses spring 56a of hammer mechanism 22a. First coupling arrangement 52a plunges into second coupling arrangement 54a, whereby tool chuck drive shaft 32a begins to drive impact generating unit 50a. When the operator stops pressing insertion tool 104a against the workpiece, spring 56a displaces tool chuck drive shaft 32a, snap die 102a, and insertion tool 104a in striking direction 98a. A rotationally fixed connection between first coupling arrangement 52a and second coupling arrangement 54a is thus opened, whereby impact generating unit 50a is shut off.

Hammer mechanism 22a has an impact generating shutoff unit 118a having a blocking element 120a, a sliding guide 122a, and an operating element 28a. In a drilling or screwing mode, blocking element 120a causes a force on snap die 102a which acts on snap die 102a in parallel to at least one force of tool chuck drive shaft 32a. The force of blocking element 120a acts on snap die 102a via tool chuck bearing 70a, tool chuck 24a, and fastening ring 116a. Due to the force of blocking element 120a, in a drilling or screwing mode, an axial displacement of snap die 102a and tool chuck drive shaft 32a and therefore an activation of impact generating unit 50a are prevented. The force of tool chuck drive shaft 32a has a component which is parallel in action, which drives snap die 102a to rotate during operation. In addition, the force has a component which is parallel in action and direction, which is caused by spring 56a via tool chuck drive shaft 32a on snap die 102a.

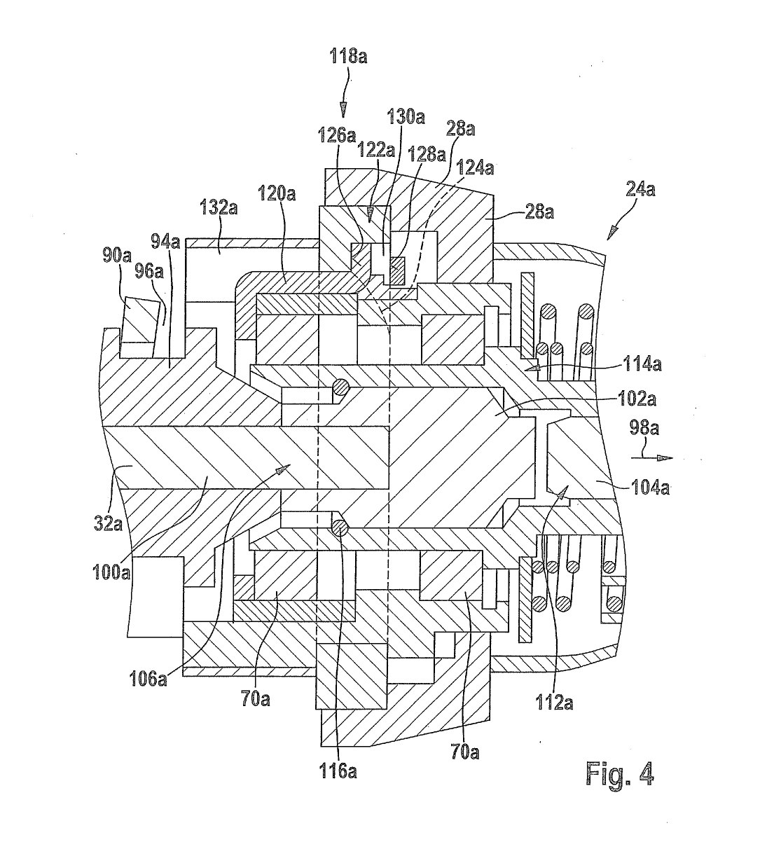

FIG. 4 shows a section oriented perpendicularly to the section of FIG. 2 and parallel to striking direction 98a, operating element 28a being situated in two different positions in the sections of FIGS. 2 and 4. Operating element 28a is configured in a ring shape. It coaxially encloses the rotational axis of tool chuck drive shaft 32a. Operating element 28a is rotatably mounted. It is connected in a rotationally fixed manner to sliding guide 122a. Sliding guide 122a is also configured as ring-shaped. Sliding guide 122a has a bevel 124a. Bevel 124a connects two faces 126a, 128a of sliding guide 122a. Faces 126a, 128a are oriented perpendicularly to striking direction 98a. Faces 126a, 128a are situated on different planes in striking direction 98a.

In a percussion drilling mode, blocking element 120a is situated in a recess 130a, which is delimited, inter alia, by bevel 124a and one of faces 126a. This face 126a is situated closer to drive motor 14a than the other face 128a. Housing 12a has a housing element 132a, which mounts the blocking element so it is rotationally fixed and displaceable in striking direction 98a. At the beginning of a percussion drilling procedure, blocking element 120a may thus be pressed together with tool chuck 24a in a direction against striking direction 98a. During a percussion drilling procedure, blocking element 120a does not cause any blocking force on tool chuck 24a. During a rotation of operating element 28a of impact generating shutoff unit 118a, blocking element 120a is moved by bevel 124a in striking direction 98a. Blocking element 120a is held in this forward position in the drilling or screwing mode. Blocking element 120a thus prevents an axial displacement of tool chuck drive shaft 32a in the drilling or screwing mode.

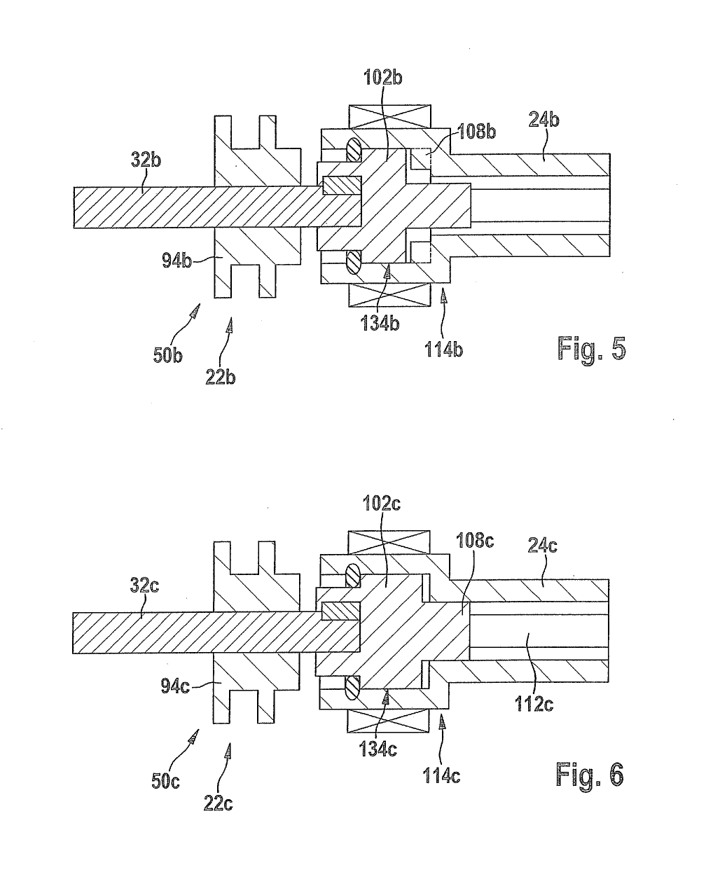

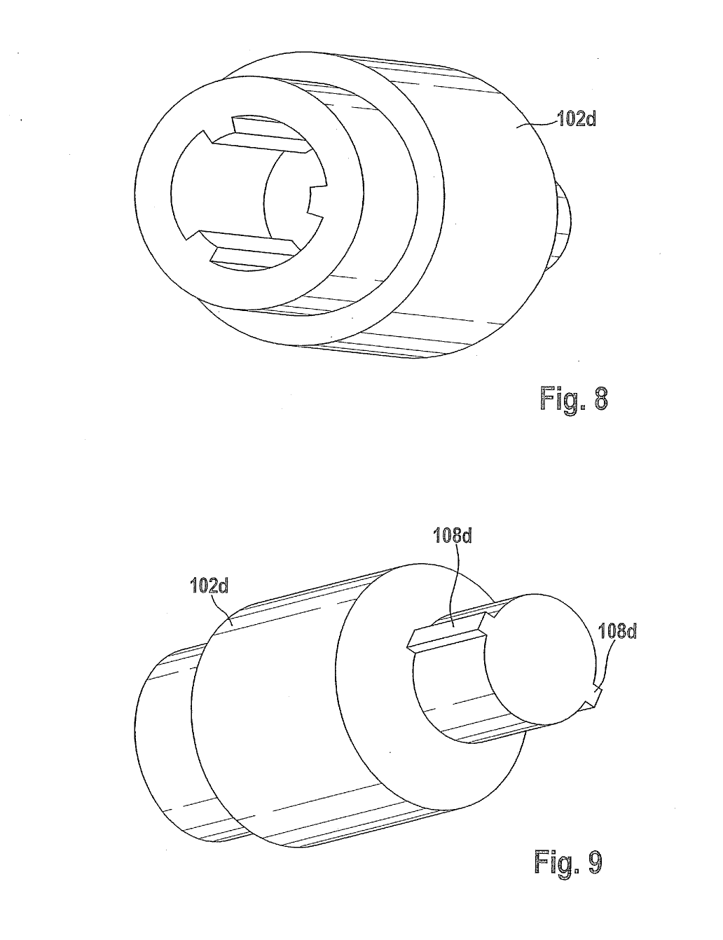

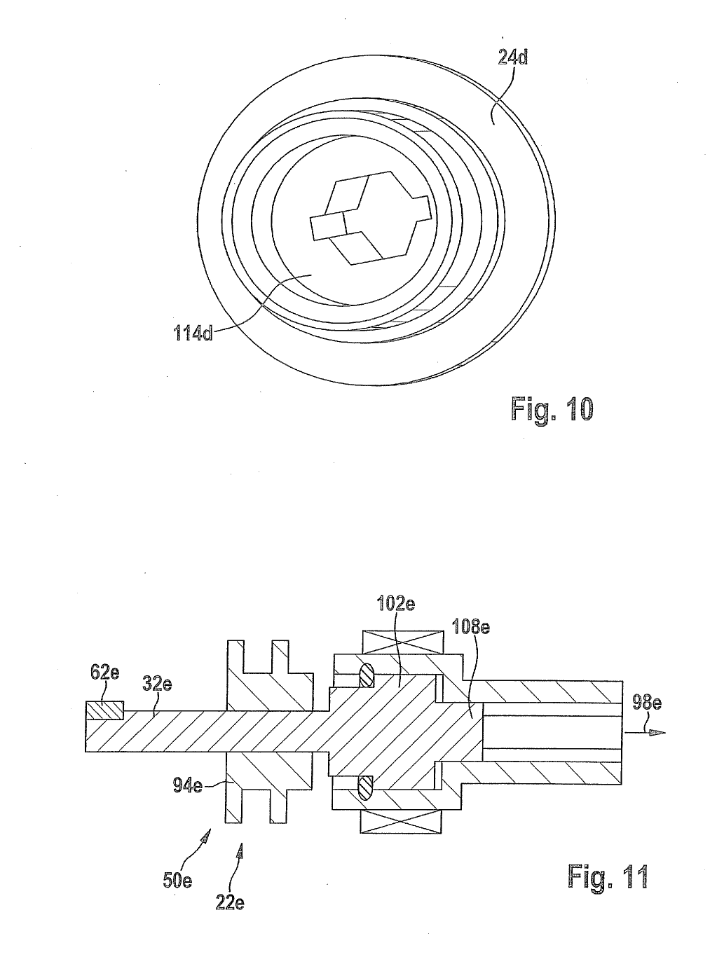

Further exemplary embodiments of the present invention are shown in FIGS. 5 through 11. The following descriptions and the drawings are essentially restricted to the differences between the exemplary embodiments, reference fundamentally being able to be made to the drawings and/or the description of the other exemplary embodiments, in particular of FIGS. 1 through 4, with respect to identically identified components, in particular with respect to components having identical reference numerals. To differentiate the exemplary embodiments, the letter a follows the reference numerals of the exemplary embodiment in FIGS. 1 through 4. In the exemplary embodiments of FIGS. 5 through 11, the letter a is replaced by the letters b through e.

FIG. 5 shows a part of a hammer mechanism 22b. A striker 94b of an impact generating unit 50b of hammer mechanism 22b is mounted so it is movable on a tool chuck drive shaft 32b of hammer mechanism 22b. Tool chuck drive shaft 32b is connected to a snap die 102b of hammer mechanism 22b so it is axially displaceable and rotationally fixed. Snap die 102b has a coupling arrangement 108b, which forms a rotationally fixed connection to a tool chuck 24b of hammer mechanism 22b in at least one operating state. Coupling arrangement 108b is situated on a side which faces toward a taper 114b of tool chuck 24b. Coupling arrangement 108b is configured as a gearing. A sealing area 134b of the snap die presses without a gearing against tool chuck 24b and advantageously prevents penetration of dust into impact generating unit 50b.

Like FIG. 5, FIG. 6 schematically shows a part of a hammer mechanism 22c. A striker 94c of an impact generating unit 50c of hammer mechanism 22c is mounted so it is movable on a tool chuck drive shaft 32c of hammer mechanism 22c. Tool chuck drive shaft 32c is connected to a snap die 102c of hammer mechanism 22c so it is axially displaceable and rotationally fixed. Snap die 102c has a coupling arrangement 108c, which forms a rotationally fixed connection to a tool chuck 24c of hammer mechanism 22c in at least one operating state. Tool chuck 24c has an insertion tool coupling area 112c, in which coupling arrangement 108c of snap die 102c at least partially engages. Insertion tool coupling area 112c is provided for the purpose of causing forces to be applied in the peripheral direction on an insertion tool during operation. In an operationally ready state, coupling arrangement 108c is at least partially situated inside a taper 114c of tool chuck 24c. Coupling arrangement 108c is configured as an external hexagon. The dimensions of the external hexagon correspond to those typically had by a bit for a screwing operation. A sealing area 134c of snap die 102c presses without a gearing against tool chuck 24c and, in an advantageous way which may be produced cost-effectively, prevents penetration of dust into impact generating unit 50c. In particular, a grease loss may be minimized.

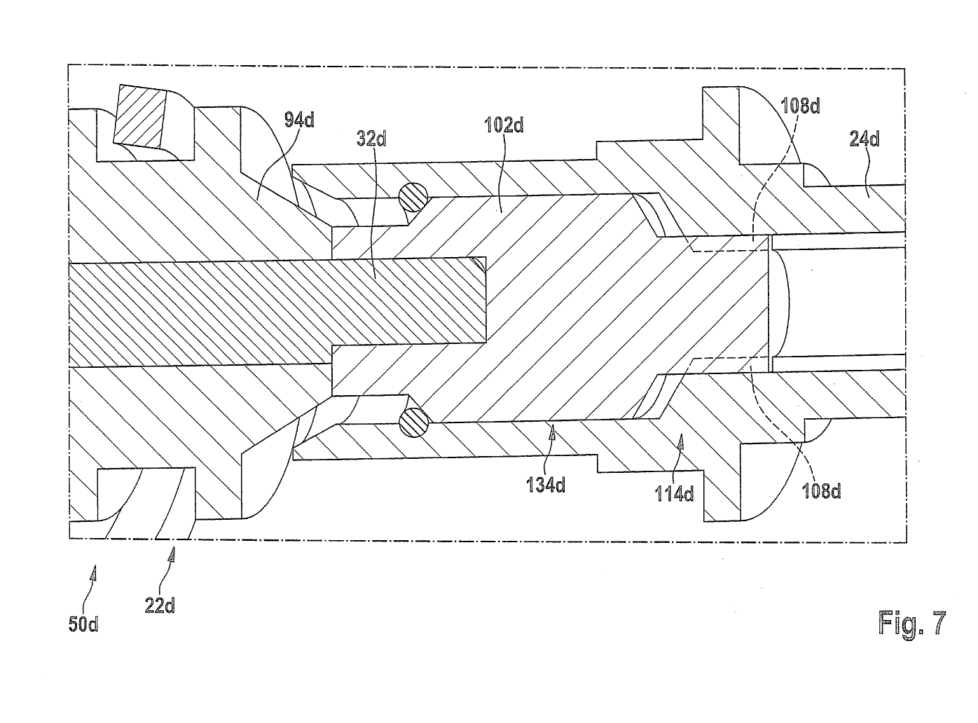

FIGS. 7 through 10 also show a part of a hammer mechanism 22d as a section and in perspective. A striker 94d of an impact generating unit 50d of hammer mechanism 22d is mounted so it is movable on a tool chuck drive shaft 32d of hammer mechanism 22d. Tool chuck drive shaft 32d is connected so it is axially displaceable and rotationally fixed to a snap die 102d of hammer mechanism 22d. Snap die 102d has a coupling arrangement 108d, which forms a rotationally fixed connection to a tool chuck 24d of hammer mechanism 22d in at least one operating state. In an operationally ready state, coupling arrangement 108d is at least partially situated inside a taper 114d of tool chuck 24d. Coupling arrangement 108d is configured as a gearing having two coupling ribs which are diametrically opposite with respect to a rotational axis. Coupling arrangement 108d has the same shape and the same dimensions as a coupling arrangement for coupling to an insertion tool. The shape and the dimensions correspond to the SDS-Quick standard. A sealing area 134d of snap die 102d presses without a gearing against tool chuck 24d.

Like FIG. 5, FIG. 11 schematically shows a part of a hammer mechanism 22e. A striker 94e of an impact generating unit 50e of hammer mechanism 22e is mounted so it is movable on a tool chuck drive shaft 32e of hammer mechanism 22e. Tool chuck drive shaft 32e is connected so it is axially fixed and rotationally fixed to a snap die 102e of hammer mechanism 22e. Tool chuck drive shaft 32e and snap die 102e are formed in one piece. During an impact, striker 94e moves tool chuck drive shaft 32e and snap die 102e jointly in striking direction 98e. Tool chuck drive shaft 32e is connected with the aid of a coupling arrangement 62e, so it is axially displaceable and rotationally fixed, to a planetary gear stage described in the exemplary embodiment of FIGS. 1 through 4.

What is claimed is:

1. A hammer mechanism, comprising:
a snap die;
a tool chuck drive shaft; and
an impact generating shutoff unit, which includes a blocking element, which is configure to prevent an axial displacement of the snap die, wherein the blocking element acts on the snap die in parallel to at least one force of the tool chuck drive shaft, at least during a drilling operation.

2. The hammer mechanism of claim 1, wherein the impact generating shutoff unit includes a sliding guide, which is configured for moving the blocking element.

3. The hammer mechanism of claim 1, wherein the impact generating shutoff unit includes a rotatably mounted operating element.

4. The hammer mechanism of claim 1, wherein a housing element, which is configured for mounting the blocking element so that it is rotationally fixed.

5. The hammer mechanism of claim 1, further comprising:
a striker, which mounts the tool chuck drive shaft so that it is movable in the striking direction in at least one operating state.

6. The hammer mechanism of claim 5, wherein the tool chuck drive shaft at least partially penetrates the striker.

7. The hammer mechanism of claim 1, further comprising:
a bearing, which is configured for mounting the tool chuck drive shaft so that it is axially displaceable.

8. The hammer mechanism of claim 1, further comprising:
a planetary gear, which drives the tool chuck drive shaft in at least one operating state.

9. The hammer mechanism of claim 1, wherein the snap die includes a coupling arrangement, which is configured to transmit a rotational movement to a tool chuck.

10. The hammer mechanism of claim 1, further comprising:
an impact generating unit; and
a coupling arrangement, which is connected in a rotationally fixed manner to the tool chuck drive shaft and is configured for driving the impact generating unit.

11. The hammer mechanism of claim 1, further comprising:
a spur gear stage, which converts a rotational speed of the tool chuck drive shaft into a higher rotational speed for impact generation.

12. A handheld tool, comprising:
a hammer mechanism, including:
a snap die;
a tool chuck drive shaft; and
an impact generating shutoff unit, which includes a blocking element, which is configure to prevent an axial displacement of the snap die, wherein the blocking element acts on the snap die in parallel to at least one force of the tool chuck drive shaft, at least during a drilling operation.
